(19) United States
(12) Patent Application Publication
(10) Pub. No.: US 2014/0322958 A1
(43) Pub. Date: Oct. 30, 2014

(54) RESILIENT MOUNTING MEMBER AND CONNECTOR HAVING RESILIENT MOUNTING MEMBER

(71) Applicant: HON HAI PRECISION INDUSTRY CO., LTD., New Taipei (TW)

(72) Inventors: YI-FANG WU, New Taipei (TW); FOO SEE WOEI, Shenzhen (MY)

(73) Assignee: HON HAI PRECISION INDUSTRY CO., LTD., New Taipei (TW)

(21) Appl. No.: 14/093,527

(22) Filed: Dec. 2, 2013

(30) Foreign Application Priority Data
Apr. 30, 2013 (CN) 2013101551543

(51) Int. Cl. H01R 13/627

(52) U.S. Cl. CPC H01R 13/6275
USPC 439/372

(57) ABSTRACT

A resilient mounting member configured for being secured to a main body of a connector comprises a pressing portion, a latching portion, and a limiting portion. The latching portion is connected to a first end of the pressing portion. The limiting portion is connected to a second end of the pressing portion. The pressing portion comprises a resilient piece extending towards the latching portion. The resilient piece is elastically deformable to resist the main body when the pressing portion is pressed, and the resilient piece drives the pressing portion to rebound when the resilient piece rebounds.

### REARGROUND

1. Technical Field

The present disclosure relates to connectors, and particularly to a resilient mounting member and a connector assembly using the resilient mounting member.

2. Description of Related Art

A resilient mounting member is used for preventing a plug connector from disengaging from a socket connector. Generally, the resilient mounting member is secured to the plug connector and comprises a latching portion and a pressing portion.

The latching portion is engaged with the socket connector. The pressing portion is elastically deformable to disengage the latching portion from the socket connector. When pressed, the plug connector can be removed from the socket connector. However, the pressing portion may not rebound to an initial position and could damage from being pressed too often or too far. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector and a resilient mounting member.

FIG. 2 is similar to FIG. 1, but viewed from another aspect.

FIG. 3 is an isometric view of the resilient mounting member of FIG. 1.

FIG. 4 is similar to FIG. 3, but viewed from another aspect.

FIG. 5 is an assembled, isometric view of the connector and the resilient mounting member of FIG. 1.

FIG. 6 is an assembled, isometric view of the connector and the resilient mounting member of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

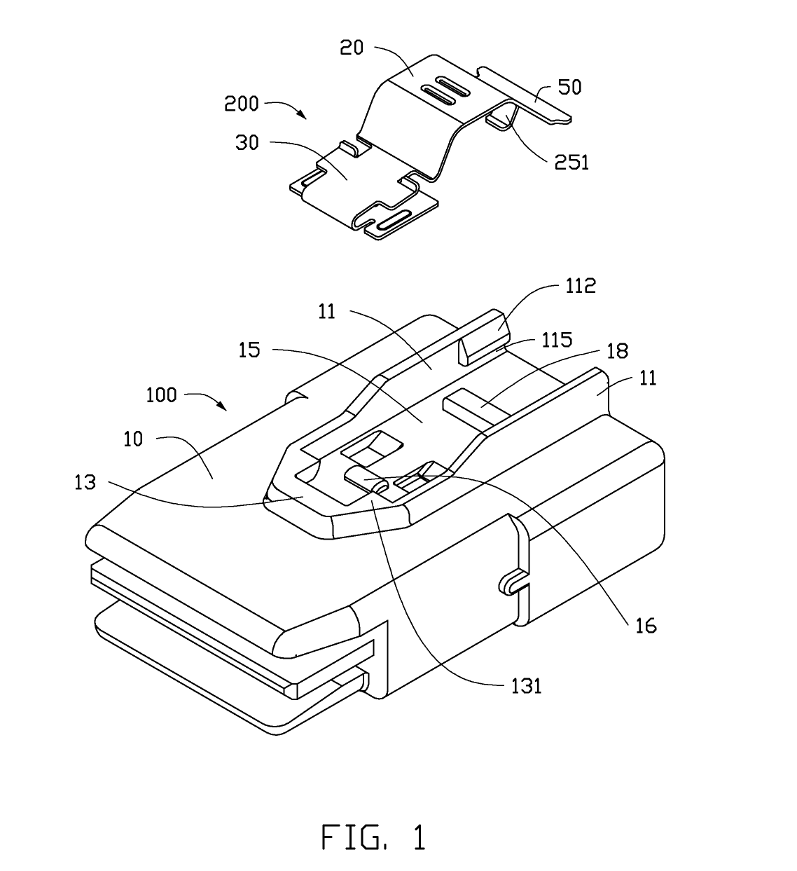

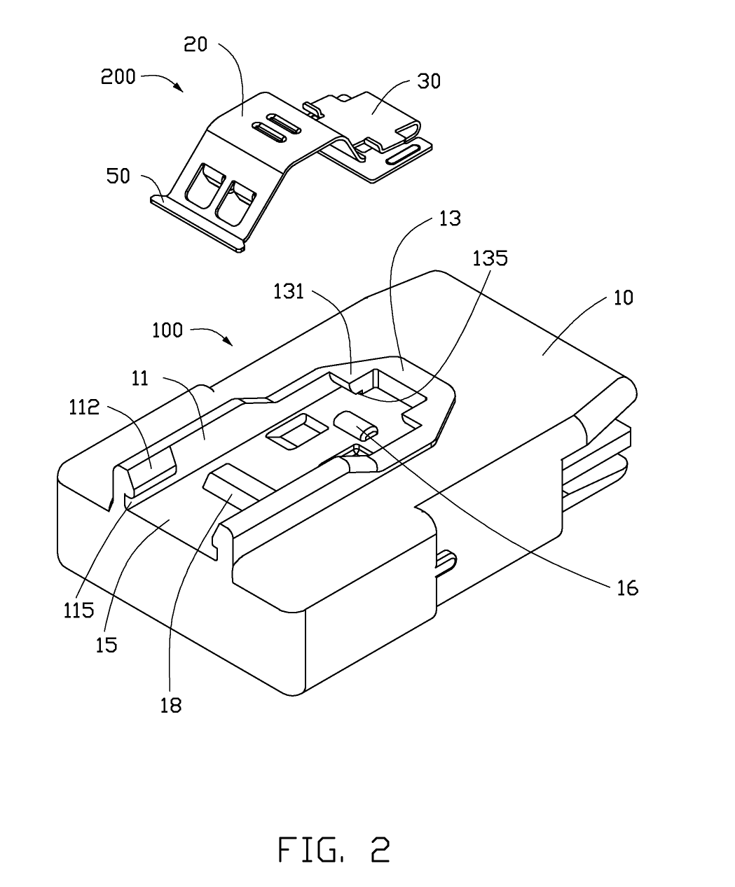

FIG. 1 and FIG. 2 show one embodiment of a connector comprising a main body 100 and a resilient mounting member 200.

The main body 100 comprises a top surface 10, two installation walls 11 extending from the top surface 10, and a sidewall 13 connected between the two installation walls 11. A receiving space 15 is cooperatively defined by the two installation walls 11 and the sidewall 13. A limiting block 112 protrudes from each installation wall 11 into the receiving space 15. A limiting slot 115 is defined between the top surface 10 and a bottom side of each limiting block 112. Two installation blocks 131 extend from the sidewall 13 towards the receiving space 15. An installation cutout 135 is defined between the top surface 10 and a bottom side of each installation block 131. A latching block 16 and a protrusion 18 protrude from the top surface 10 and are located in the receiving space 15.

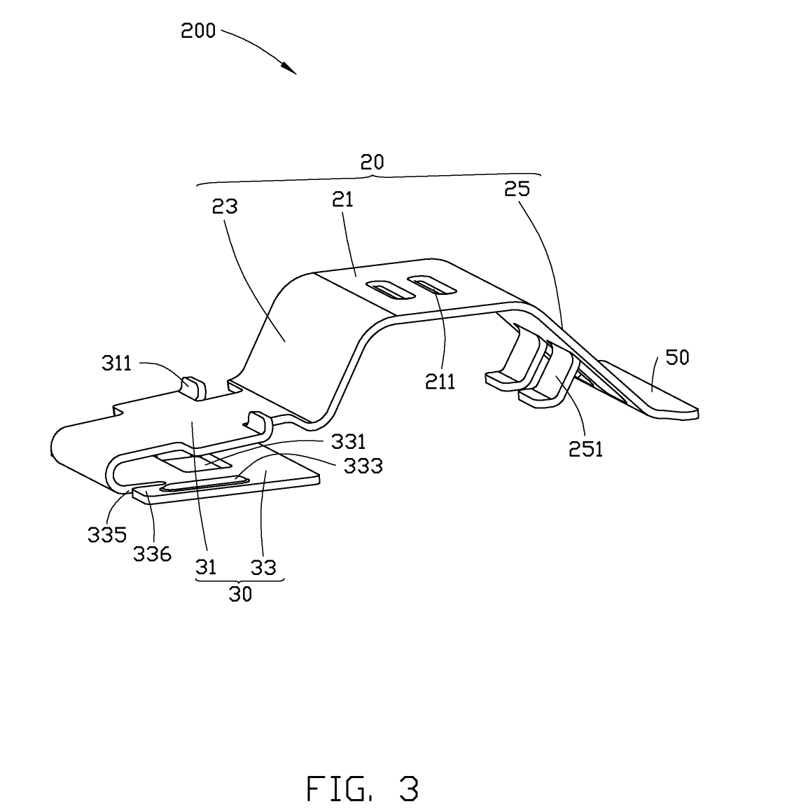

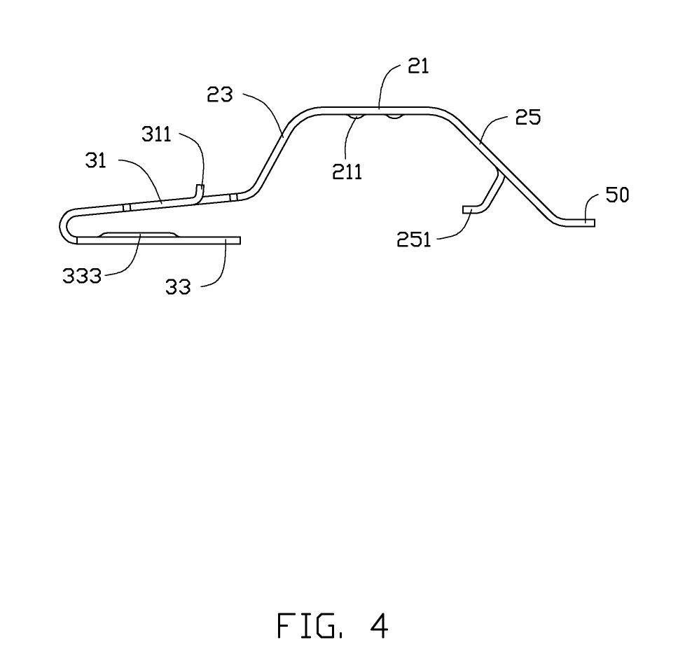

Referring to FIG. 3 and FIG. 4, the resilient mounting member 200 comprises a pressing portion 20, a latching portion 30, and a limiting portion 50.

The pressing portion 20 comprises a pressing piece 21, a front resilient arm 23, and a rear resilient arm 25. The front resilient arm 23 and the rear resilient arm 25 extend from opposite ends of the pressing piece 21. In one embodiment, an obtuse angle is defined between the pressing piece 21 and each of the front resilient arm 23 and the rear resilient arm 25. The latching portion 30 is connected to a distal end of the front resilient arm 23. Two resilient pieces 251 extend from the rear resilient arm 23 towards the front resilient arm 23. An extending direction of each resilient piece 251 is substantially parallel to an extending direction of the front resilient arm 23. Two first strengthening ribs 211 protrude down from the pressing piece 21.

The latching portion 30 is substantially U-shaped and comprises an installation piece 31 and a latching piece 33 connected to the installation piece 31. The installation piece 31 is connected to the distal end of the front resilient arm 23 and extends towards a first direction away from the rear resilient arm 25. The latching piece 33 is bent about 180 degrees from the installation piece 31 and extends toward the rear resilient arm 25. A pair of hooks 311 extends up from the front resilient arm 23. The hooks 311 are used for engaging with an inner surface of an inserting slot (not shown) when the connector is inserted into the inserting slot. The latching piece 33 defines two cutouts 335. Amounting piece 336 is formed adjacent to each cutout 335. The mounting pieces 336 are received in the installation cutouts 135.

The limiting portion 50 extends from a distal end of the rear resilient arm 25 towards a second direction, which is away from the front resilient arm 23 and opposite to the first direction. In one embodiment, the limiting portion 50 is substantially parallel to the latching piece 33.

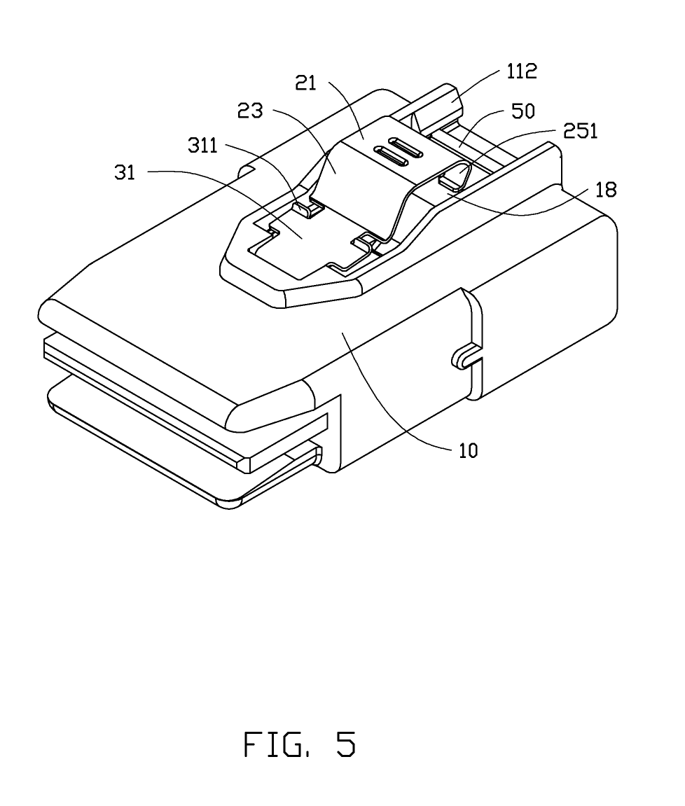

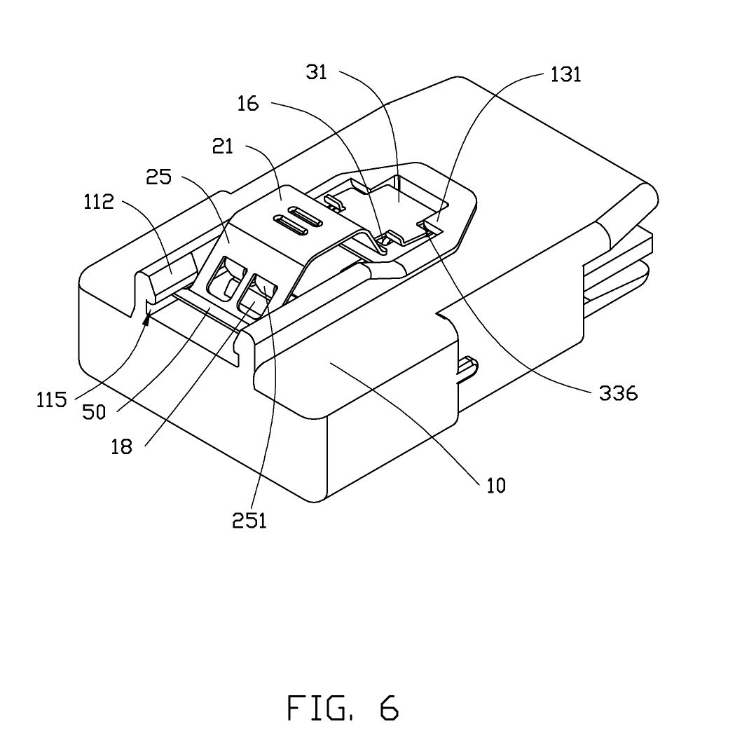

FIG. 5 and FIG. 6 show that in assembly, the limiting portion 50 of the resilient mounting member 200 is received into the limiting slot 115, and the resilient pieces 251 abut the protrusion 18. The front resilient arm 23 is pressed towards the rear resilient arm 25 to elastically deform the front resilient arm 23, to align the latching block 16 with the receiving hole 331, and align the mounting pieces 336 with the installation cutouts 135. In this position, the front resilient arm 23 is released and restored, so that the latching block 16 is received in the receiving hole 331, thereby preventing the resilient mounting member 200 from being moved along a direction substantially parallel to the top surface 10. Simultaneously, the mounting pieces 336 are received in the installation cutouts 135, thereby preventing the resilient mounting member 200 from being moved along a direction substantially perpendicular to the top surface 10. Thus, the resilient mounting member 200 is secured to the main body 100.

When the connector is inserted into the inserting slot, the hooks 311 engage with an inner surface of the inserting slot. To remove the connector from the inserting slot, the pressing portion 20 is pressed to elastically deform the installation piece 31 toward the latching piece 33 to remove the hooks 311 from the hole, thereby allowing the connector to be removed from the inserting slot. The resilient pieces 251 are elastically deformed to resist the protrusion 18 when the pressing portion 20 is pressed, thereby preventing the pressing portion 20 from damage by being pressed too far, too hard, or too often. After the connector is removed from the inserting slot, the resilient pieces 251 rebound to exert an elastic force on the pressing portion 20 and the installation piece 31, thereby driving the pressing portion 20 and the installation piece 31 to rebound to an initial position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A resilient mounting member, configured for being secured to a main body of a connector, comprising:
a pressing portion having a first end and a second end opposite to the first end;
a latching portion connected to the first end of the pressing portion and configured for being resiliently secured to the main body;
a hook extending from the latching portion;
a limiting portion connected to the second end of the pressing portion and configured for being secured to the main body; and
a resilient piece extending from the second end of the pressing portion;
wherein when the pressing portion is pressed, the pressing portion is elastically deformed, and the resilient piece is elastically deformed and resists the main body; and when the resilient piece rebounds, the resilient piece exerts an elastic force to rebound the pressing portion.

2. The resilient mounting member of claim 1, wherein the pressing portion comprises a pressing piece, a front resilient arm, and a rear resilient arm; the front resilient arm and the rear resilient arm are slantingly connected to opposite sides of the pressing piece; the latching portion connects to the front resilient arm; the limiting portion connects to the rear resilient arm; and the resilient piece extends from the rear resilient arm.

3. The resilient mounting member of claim 2, wherein a first obtuse angle is defined between the front resilient arm and the pressing piece; a second obtuse angle is defined between the rear resilient arm and the pressing piece; and the resilient piece extends from the rear resilient arm towards the front resilient arm.

4. The resilient mounting member of claim 3, wherein an extending direction of the resilient piece is substantially parallel to an extending direction of the front resilient arm.

5. The resilient mounting member of claim 2, wherein the latching portion comprises an installation piece connected to the front resilient arm and a latching piece connected to the installation piece; the hook extends from the installation piece; and the latching piece is bent about 180 degrees from the installation piece thereby forming a U shape with the installation piece.

6. The resilient mounting member of claim 5, wherein the latching piece defines a receiving hole engaging with a latching block protruding from the main body.

7. The resilient mounting member of claim 5, wherein the latching piece defines a cutout, and the latching piece comprises a mounting piece formed adjacent to the cutout, and the matching piece engaging with an installation cutout of the main body of the connector.

8. A resilient mounting member, configured for being secured to a main body of a connector, comprising:
a pressing portion having a first end and a second end opposite to the first end;
a latching portion connected to the first end of the pressing portion and configured for being resiliently secured to the main body; and
a limiting portion connected to the second end of the pressing portion and configured for being secured to the main body, and the limiting portion;
wherein the pressing portion comprises a resilient piece extending towards the latching portion; when the pressing portion is pressed, the pressing portion is elastically deformed, and the resilient piece is elastically deformed and resist the main body; and when the resilient piece rebounds, the resilient piece exerts an elastic force to rebound the pressing portion.

9. The resilient mounting member of claim 8, wherein the pressing portion further comprises a pressing piece, a front resilient arm, and a rear resilient arm; the front resilient arm and the rear resilient arm are slantingly connected to opposite sides of the pressing piece; the latching portion connects to the front resilient arm; the limiting portion connects to the rear resilient arm; and the resilient piece extends from the rear resilient arm.

10. The resilient mounting member of claim 9, wherein a first obtuse angle is defined between the front resilient arm and the pressing piece; a second obtuse angle is defined between the rear resilient arm and the pressing piece; and the resilient piece extends from the rear resilient arm towards the front resilient arm.

11. The resilient mounting member of claim 10, wherein an extending direction of the resilient piece is substantially parallel to an extending direction of the front resilient arm.

12. The resilient mounting member of claim 9, wherein the latching portion comprises an installation piece connected to the front resilient arm and a latching piece connected to the installation piece; the hook extends from the installation piece; and the latching piece is bent 180 degrees from the installation piece, thereby forming a U shape with the installation piece.

13. The resilient mounting member of claim 9, wherein the latching piece defines a receiving hole and a cutout.

14. A connector comprising:
a main body; and
a resilient mounting member comprising:
a pressing portion with a first end and a second end opposite to the first end;
a latching portion connected to the first end of the pressing portion and resiliently secured to the main body;
a hook extending from the latching portion;
a limiting portion connected to the second end of the pressing portion and secured to the main body; and
a resilient piece extending from the second end of the pressing portion;
wherein when the pressing portion is pressed, the pressing portion is elastically deformed, and the resilient piece is elastically deformed and resist the main body; and when the resilient piece rebounds, the resilient piece exerts an elastic force to rebound the pressing portion.

15. The connector of claim 14, wherein the main body comprises a top surface and a protrusion extending from the top surface, and the resilient piece abuts the protrusion.

16. The connector of claim 15, wherein the main body further comprises two installation walls, a sidewall connected to the two installation walls, and a limiting block extending from each installation wall; a limiting slot is defined between the limiting block and the top surface; and the limiting portion is engaged in the limiting slot.

17. The connector of claim 16, wherein the main body further comprises an installation block extending from the sidewall, and an installation cutout is defined between the installation block and the top surface; and a part of the latching portion is engaged in the installation cutout, preventing the resilient mounting member from moving along a direction away from the top surface.

18. The connector of claim 17, wherein a receiving space is defined by the two installation walls and the sidewall, and a latching block extends from the top surface and is located in the receiving space; the latching portion defines a receiving hole, and the latching block is engaged in the receiving hole, preventing the resilient mounting member from moving along a direction substantially parallel to the top surface.

19. The connector of claim 14, wherein the pressing portion comprises a pressing piece, a front resilient arm, and a rear resilient arm; the front resilient arm and the rear resilient arm are slantingly connected to opposite sides of the pressing piece; the latching portion connects to the front resilient arm; the limiting portion connects to the rear resilient arm; and the resilient piece extends from the rear resilient arm.

20. The connector of claim 19, wherein a first obtuse angle is defined between the front resilient arm and the pressing piece; a second obtuse angle is defined between the rear resilient arm and the pressing piece; the resilient piece extends from the rear resilient arm towards the front resilient arm; and an extending direction of the resilient piece is substantially parallel to an extending direction of the front resilient arm.
